(19) United States
(12) Patent Application Publication
(10) Pub. No.: US 2013/0197731 A1
(43) Pub. Date: Aug. 1, 2013

(54) HILL HOLDING CONTROL IN AN ELECTRIC VEHICLE

(71) Applicants: Dan Schum, Lake Balboa, CA (US); Kurt Mitts, Pontiac, MI (US); Georg Ritzert, Nuremberg (DE); Damien Verdier, Toulouse (FR)

(72) Inventors: Dan Schum, Lake Balboa, CA (US); Kurt Mitts, Pontiac, MI (US); Georg Ritzert, Nuremberg (DE); Damien Verdier, Toulouse (FR)

(73) Assignee: Coda Automotive, Inc., Los Angeles, CA (US)

(21) Appl. No.: 13/360,120

(22) Filed: Jan. 27, 2012

(51) Int. Cl. B60L 15/20; B60T 8/24

(52) U.S. Cl. 701/22

(57) ABSTRACT

Methods and systems are disclosed for controlling an electric vehicle. The method includes determining that the vehicle is stopped on a slope in an unparked mode without an accelerator or brake request. A holding force may be applied to hold the vehicle in the stopped position on the slope. After the vehicle has been stopped on the slope in the unparked mode without an accelerator or brake request for a predetermined amount of time, the holding force may be reduced to remind a driver that the vehicle is in the unparked mode.

### BACKGROUND

A traditional vehicle with an internal combustion engine and an automatic transmission will deliver a small constant amount of torque to the wheels while in drive or reverse even when the accelerator pedal is not depressed. This torque is referred to as a “creep torque.” The creep torque is equal to the torque produced by the engine when idling with the throttle blade in the idle position.

Depending on the slope the vehicle is traversing and the vehicle mass, creep torque may accelerate the vehicle from a stopped position to different “creep speeds.” For example, on a flat road the creep torque may result in a creep speed of 5 mph while on a downhill slope the creep speed could reach 20 mph or more. Similarly, when facing uphill the creep speed might be 2 mph on a particular slope. However, as the uphill slope is increased, the creep speed will decrease until the vehicle is stopped on the slope in what is known as a hill hold condition. This situation is depicted in FIG. 1 where a vehicle 2 is facing up a slope 4. The applied creep torque 6 is balanced by the downhill force 8 due to the vehicles mass. In this case the vehicle will remain stopped on the slope even though it is not in a park mode or the brake is not applied. As the slope increases, the downhill force will become greater than the creep torque and the vehicle may begin to move backwards opposite the applied creep torque.

While electric vehicles do not inherently have a generated creep torque, many electric vehicles include a creep torque provided through software commands to the electric motor to simulate the driving experience of a more traditional vehicle with an internal combustion engine. The supplied creep torque is generally constant in the absence of accelerator and brake inputs from the drivers. Therefore, in some instances, it is possible that an electric vehicle with an applied creep torque could be subject to “hill hold” situations.

In addition to “hill hold” resulting from an applied creep torque, electric vehicles may include arrangements that specifically avoid roll back on a slope, by, for example, commanding a torque equivalent to the downhill force to restrain the vehicle or initiating plug braking and/or other forms of regenerative braking.

### SUMMARY

The inventors have recognized that providing the electric vehicle with a creep torque to indefinitely hold the vehicle on the hill may be disadvantageous. For example, a driver may inadvertently exit the vehicle in an unparked mode, with the vehicle held on a slope in the “hill hold” condition. To address this possibility, the inventors have discovered that it might be beneficial to reduce or terminate an applied force holding the vehicle on the slope. In this way, the vehicle may move slightly down the slope in an effort to remind the driver that the vehicle is not adequately held in park or some other secured mode. For example, the applied motor torque simulating creep torque may be reduced or terminated after a period of time. Alternatively, or in addition to the above, the electric vehicle's control system may initiate a parking mode after a period of time.

In one embodiment, a method for controlling motion of an electric vehicle includes determining that the vehicle is stopped on a slope in an unparked mode without an accelerator or brake request. A holding force may be applied that holds the vehicle in the stopped position on the slope. After the vehicle has been held by the holding force for a predetermined amount of time, the holding force may be reduced to remind a driver that the vehicle is in the unparked mode.

In another embodiment, a system configured for controlling an electric vehicle includes a processor and memory. The memory includes instructions to: apply a holding force that holds the vehicle in a stopped position on a slope; and if the vehicle speed is substantially zero for a predetermined amount of time and there is no accelerator or brake request, reduce the holding force to remind a driver that the vehicle is in an unparked mode.

In yet another embodiment, a method for controlling an electric vehicle includes the steps of sensing a vehicle speed; sensing if a driver vehicle door is open; sensing accelerator and brake inputs; and applying a parking mode if the vehicle speed is substantially zero for a predetermined amount of time, the driver vehicle door is open, and there is no accelerator or brake request.

In one embodiment, a system configured for controlling an electric vehicle includes a processor and memory. The memory includes instructions to: sense a vehicle speed; sense if a driver vehicle door is open; sense accelerator and brake inputs; and apply a parking mode if the vehicle speed is substantially zero for a predetermined amount of time, the driver vehicle door is open, and there is no accelerator or brake request.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a prior art schematic representation of a vehicle holding on a hill;

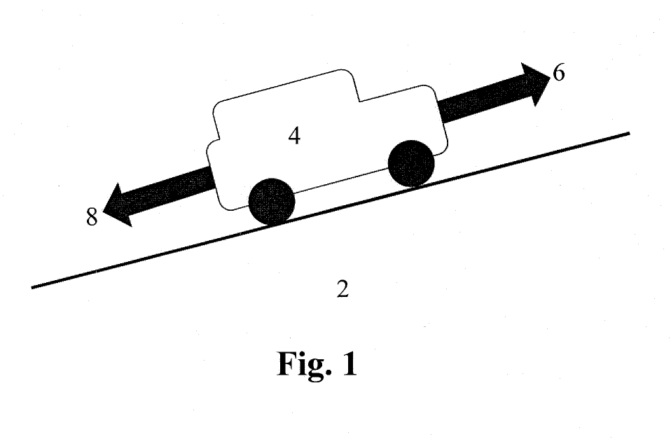

FIG. 2 is a schematic representation of a drive system; and

FIG. 3 is an exemplary flow diagram of the operation of an electric vehicle during a hill hold situation.

### DETAILED DESCRIPTION

When driving a traditional vehicle with an internal combustion engine, the vehicle makes audible noise and/or vibrations that are noticeable by the driver. The noise and/or vibrations are apparent when the vehicle is parked, moving, and stopped in an unparked mode. Thus, a driver will generally be aware that a vehicle is still on. However, an electric vehicle makes almost no noise when in ready mode, i.e. the vehicle is on but there is no accelerator request. So, it is possible that, in some cases, a driver may need to be reminded that the vehicle is in a hill hold condition.

As indicated above, the inventors have recognized that it would be advantageous to provide a control system for an electric vehicle or a hybrid electric vehicle that can either make the driver aware that only creep torque is holding the vehicle on a slope, and/or take the vehicle out of a ready mode and place it into a park mode.

For the sake of clarity the following description discusses the application and reduction of an applied creep torque for the purposes of reminding the driver that the vehicle may be in a hill hold condition. However, while the methods and systems detailed below are described in regards to reducing a creep torque, the current disclosure is not limited in this manner. Instead the current disclosure should be interpreted broadly as being applicable to any holding force applied to an electric vehicle while in the ready mode that may result in a hill hold condition. Systems that may be implemented to provide a hill hold function include but are not limited to, the primary braking system, a secondary braking system, a commanded torque to prevent downhill movement on a slope, regenerative braking such as plug braking, and any other applicable system capable of holding a vehicle on a slope. Therefore, the current disclosure should be interpreted generally as detecting a hill hold condition and subsequently removing or reducing the holding force thereby permitting the vehicle to move slightly to remind the driver that the vehicle is unparked. For example, a commanded creep torque may be reduced or a hydraulic pressure applied to a braking system may be lowered to reduce a frictional braking force. In both cases, the applied holding force maintaining the vehicle stopped on a slope is being reduced. Thus, the concepts detailed below are equally applicable to both.

In one embodiment, a control system for controlling an electric vehicle monitors and senses when the vehicle is being held on a hill by the creep torque while in ready mode. Alternatively, the control system for the electric vehicle may monitor vehicle inputs that may indicate a likely hill hold. Once the hill hold is sensed, or a likely hill hold is indicated, the control system may alert the driver to the situation that the car is not in park mode and should not be left in this state for an extended period of time.

In one embodiment, to monitor whether or not the vehicle is stopped on a slope, the control system may monitor inputs regarding the vehicle speed, the accelerator input, the brake input, the applied creep torque, and/or other appropriate conditions. As noted above, an electric vehicle may apply a creep torque in the absence of an accelerator or brake input. Furthermore, the creep torque may result in the vehicle accelerating unless it is on a slope that opposes the creep torque. Therefore, if the control system senses that a creep torque is applied, and the vehicle is not moving, the vehicle is likely stopped on a slope. Hence, it follows that the control system may sense a hill hold situation when there is no accelerator or brake requests, a creep torque is applied to the vehicle, the sensed vehicle speed is approximately zero, and the vehicle is not in park mode. In other embodiments, the hill hold situation may be sensed by monitoring the vehicle speed and determining the slope of the road the vehicle is located on. The slope of the road may be determined using positional information, accelerometers, electronic levels, and other appropriate sensors. In such an embodiment, a hill hold situation may be indicated when a slope greater than a threshold slope is sensed, the vehicle speed is approximately zero, there are no accelerator or brake requests, and the vehicle is not in a park mode. While several methods have been disclosed to determine a hill hold situation, it should be understood that this may be accomplished in any number of ways and does not limit the current disclosure.

Once a hill hold condition has been sensed, the control system may remind the driver of the situation. In one embodiment, the control system may remind the driver by, after a predetermined period of time, reducing the creep torque applied to the vehicle in a controlled manner. The reduction in the creep torque may result in the vehicle moving in the downhill direction. It is this movement that reminds the driver that it was only the creep torque keeping the vehicle still and not some other more positive holding arrangement, such as being in park mode or brakes applied. After the driver has been reminded of the condition, the driver may apply the brakes, accelerate, or park the vehicle to return the vehicle to normal operation. In one embodiment, the removal of the creep torque is gradual to avoid sudden down hill motion. In some embodiments, it may be desirable to control the reduced creep torque such that a speed of the vehicle may be limited to a predetermined speed. The predetermined speed may be selected to be slow enough to lessen any abrupt changes with vehicle motion. In some instances the vehicle's speed may be limited to between 1 to 2 kph. In other instances it may be desirable to limit the speed of the vehicle to less than 0.5 kph, 1 kph, 2kph, 3 kph, 4 kph, 5 kph, or any other desirable speed.

In some embodiments, the control system may reduce the applied creep torque after a predetermined amount of time after the hill hold condition has been sensed/initiated. However, if the predetermined amount of time is too short it may lead to unwanted reductions in the creep torque during driving such as when a driver is switching between the brake and accelerator pedal while on a hill. If the creep torque is reduced in this situation, it could lead to unwanted backwards movement prior to depressing the accelerator pedal. Conversely, if the predetermined amount of time is too long it may allow a driver to exit the vehicle prior to being reminded of the hill hold condition thus leaving the car stopped on a slope without being in a parking mode. Therefore, the predetermined amount of time may be selected to be long enough to avoid unwanted reductions in creep torque during driving, but short enough to alert the driver prior to their exiting the car. In one embodiment, the predetermined amount of time may be short enough to preclude even opening the door. In some embodiments the predetermined amount of time may be approximately 0.3 seconds, 0.4 seconds, 0.5 seconds, 1 second, 2 seconds, 3 seconds, 4 seconds, 5 seconds, or, in some embodiments, even up to 10 seconds or any other suitable time period.

In another embodiment, the control system may end the hill hold condition by parking the vehicle. This may be done in addition to, or separately from, the above noted arrangement of reminding the driver. The control system may force the vehicle into a parking mode when a hill hold condition has been sensed in a manner similar to that disclosed above and has remained in that condition for a predetermined amount of time. However, in some embodiments, in addition to the other parameters sensed, the control system may also sense if a driver vehicle door is open. If a hill hold condition has been sensed for a predetermined amount of time and a driver vehicle door has been opened, it may indicate that the driver is exiting the vehicle or has already exited the vehicle. In such an instance, the control system may command the vehicle to either terminate or reduce the creep torque and/or enter a parking mode.

Similar to the embodiment detailed above regarding the reduction in applied creep torque, it may be desirable to avoid applying an unwanted parking mode such as might occur if a driver were to open and close a door that is ajar while stopped on a hill To avoid this situation, the system may apply the parking mode after the hill hold and/or open door has been sensed for a predetermined time. In some embodiments the predetermined time may be approximately 0.5 seconds, 1 second, 2 seconds, or any other suitable time period.

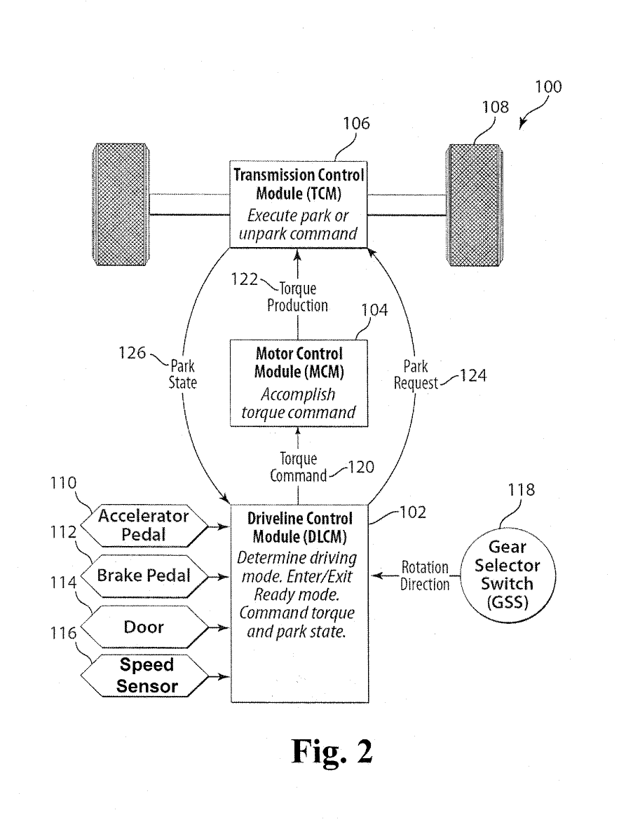

Turning to FIG. 2, a schematic representation of one embodiment of a drive system 100, which may be used to implement the above disclosed control system and methods of operation, is shown. The drive system may include a driveline control module (DLCM) 102. The DLCM may receive driver inputs from the accelerator pedal 110, brake pedal 112, door sensor 114, speed sensor 116, gear selector switch 118, and/or any other suitable input. The gear selector switch may supply information related to the desired direction of rotation of the wheels, i.e. reverse, drive, neutral, or park. The accelerator and brake pedals may provide the accelerator and brake request related to the driver depressing one or both of the pedals. The door sensor may provide information related to whether the driver's door is open or closed. By analyzing the above inputs, the DLCM may calculate a requested value and direction of torque. The DLCM may also determine, among others, whether or not to command the vehicle to enter or exit the various drive, ready, and park modes.

During vehicle operation, after determining the requested mode of operation and analyzing the provided inputs, the DLCM may send a torque command 120 to the Motor Control Module (MCM) 104. The torque command sent to the MCM may include both the direction and value of the requested torque. Once received, the MCM may command the motor to provide torque 122 to the drive wheels 108. The DLCM may also control park requests by sending a parking request signal 124 to transmission control module (TCM) 106 and may monitor the parking state 126 transmitted by the TCM to the DLCM. The parking request may be either a request to park or unpark the vehicle, and the TCM executes the park or unpark command. In some embodiments, the park mode may include moving a park pawl into a locking position, thus preventing rotation of the transmission and hence rotation of the wheels. Of course, the present disclosure is not limited in this regard and other “park” arrangements may be employed.

When implementing the above disclosed methods regarding a hill hold condition, the DLCM may first determine if the vehicle is in the ready mode, drive mode, parking mode, or any other applicable operation mode. When the vehicle is in the ready mode, the DLCM may command a creep torque to be applied and may also monitor the inputs from the accelerator pedal, brake pedal, door sensor, and speed sensor to determine when the vehicle is in a hill hold condition. When a hill hold condition has occurred and it is determined that the hill hold condition has reached a predetermined amount of time, the DLCM may command the MCM to decrease the applied creep torque. If the vehicle begins to roll down a slope, the DLCM may vary the commanded torque to limit the downhill speed to a predetermined speed. In some instances the vehicle's speed may be limited to between 1 to 2 kph. In other instances it may be desirable to limit the speed of the vehicle to less than 0.5 kph, 1 kph, 2 kph, 3 kph, 4 kph, 5 kph, or any other desirable speed. Alternatively, or in addition to reducing the creep torque, if the door sensor indicates that the driver's door is also open, the DLCM may send a command to the MCM to terminate the creep torque and may send a separate parking request to the TCM to park the vehicle. It is possible that a DLCM could implement either one of the above noted methods or possibly both as they are not mutually exclusive from one another.

While the DLCM has been described as analyzing the different inputs and controlling the various components of the drive system, the current disclosure is not limited in this fashion. It should be understood that the various informational inputs, processing, and commands could be distributed between the DLCM, MCM, and TCM. Alternatively, the informational inputs and processing of the information could be conducted by a processor separate from the above noted drive system and could provide an external command to the drive system to alert the driver to a hill hold situation using the above disclosed methods. Similarly, fewer, additional or different vehicle controllers may be implemented, as the current disclosure is not limited in this respect. Consequently, the current disclosure is not limited as to which specific component, or components, of a vehicle that receives the inputs, analyzes the same, determines a hill hold condition and then commands the drive system to remind the driver of the condition and/or place the vehicle in a park mode.

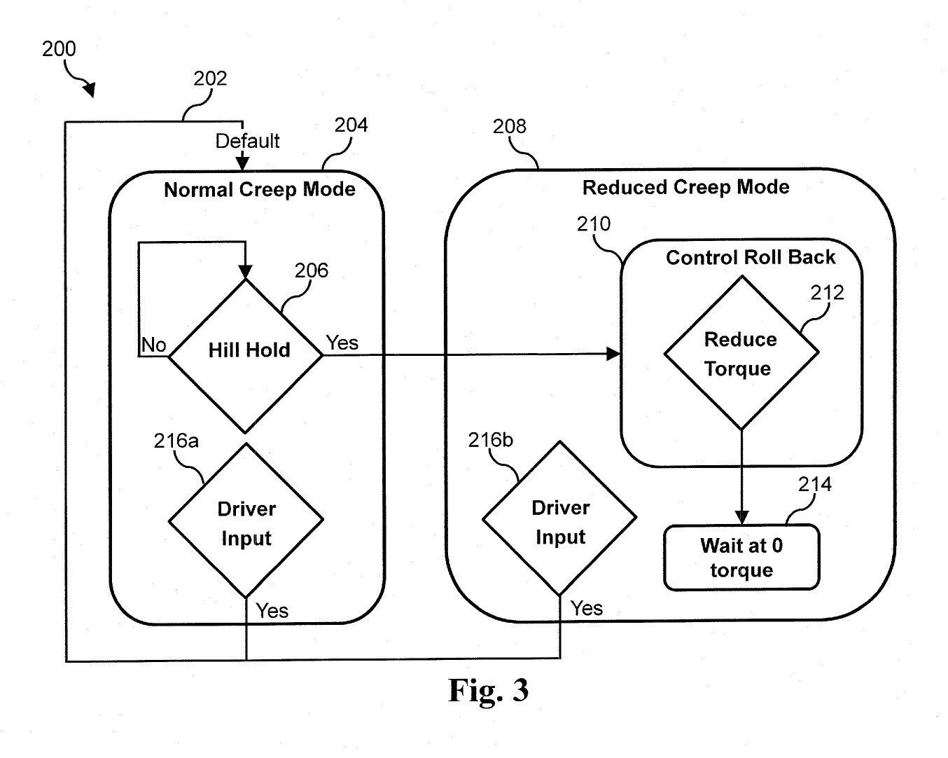

FIG. 3 presents an exemplary flow diagram of the operation of a vehicle 200. When operating in drive or ready mode, the vehicle may operate in a default mode 202 wherein the vehicle is operated according to the requested inputs from the brake and accelerator pedals. When the accelerator and brake requests are removed, i.e. the pedals are not depressed, the vehicle may enter a normal creep torque mode 204.

While in the creep torque mode, a creep torque may be applied to the vehicle, and the speed, accelerator input, and brake input may be monitored in step 206 to detect if a hill hold condition exists. If the speed is approximately zero and there is no accelerator or braking request, a counter may be started. If the counter reaches a value equivalent to a predetermined time, the vehicle may enter a reduced creep torque mode 208 in which the creep torque is reduced in a controlled manner in step 210 by a speed controller permitting the vehicle to roll at a predetermined speed, for example less than approximately 2 kph. On the other hand, if a hill hold condition is not detected, the vehicle may continue to operate in the normal creep torque mode. The above noted speed controller may either be a closed loop or open loop controller as the current disclosure is not limited in this fashion. To avoid an undesired reduction in creep torque, the predetermined time may be greater, by an appropriate buffer, than the mean time it takes a driver to release the brake pedal and depress the accelerator pedal. The buffer may be approximately 0.5 seconds, 1 second, or any suitable time period. In some embodiments, the total predetermined time may be approximately 0.3 seconds, 0.4 seconds, 0.5 seconds, 1 second, 2 seconds, 3 seconds, 4 seconds, 5 seconds, or, in some embodiments, even up to 10 seconds or any other suitable time period.

In order to stop or reverse the movement of the vehicle down the slope, it may be desirable to permit the driver to resume normal operation of the vehicle in the default operation mode. Therefore, when operating in either the normal or reduced creep torque modes the vehicle may be returned to the default operation mode at any time by supplying a driver input such as an accelerator or braking request, i.e. depressing the accelerator or brake pedals, in step 216a or 216b. Once in the default operation mode, the supplied driving torque, or braking force, will correspond to that requested by the driver and the vehicle may either brake or accelerate as desired by the driver.

In an alternative concept, instead of reducing the holding force to remind the driver of a hill hold condition, the creep torque may be increased to overcome the downhill force regardless of the incline of the slope. Thus, the vehicle could slowly move up the hill to remind the driver that the vehicle is in a ready mode when the brake or parking mode is not applied. To implement such a concept, a torque could be commanded that is always greater than the downhill force in the absence of an accelerator or braking input.

The above-described embodiments can be implemented in any of numerous ways. For example, the embodiments may be implemented using hardware, software or a combination thereof. When implemented in software, the software code can be executed on any suitable processor or collection of processors associated with a memory containing instructions to implement the desired method. The processors and memory may be provided in a single device or may be distributed among multiple devices.

Further, embodiments may include a computer readable storage medium (or multiple computer readable media) (e.g., memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more processors, perform methods that implement the various embodiments of the invention discussed above. As is apparent from the foregoing examples, a computer readable storage medium may retain information for a sufficient time to provide computer-executable instructions in a non-transitory form.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only. Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

What is claimed is:

1. A method for controlling motion of an electric vehicle comprising:
determining that the vehicle is stopped on a slope in an unparked mode without an accelerator or brake request;
applying a holding force that holds the vehicle in the stopped position on the slope; and
after the vehicle has been held by the holding force for a predetermined amount of time, reducing the holding force to remind a driver that the vehicle is in the unparked mode.

2. The method of claim 1 further comprising controlling the reduced holding force to limit a speed of the vehicle to a predetermined speed.

3. The method of claim 1 further comprising sensing a vehicle speed.

4. The method of claim 1 further comprising sensing at least one of an accelerator input and a brake input.

5. The method of claim 1, wherein applying a holding force further comprises applying a creep torque.

6. The method of claim 1, wherein applying a holding force further comprises applying a brake torque.

7. The method of claim 1, wherein controlling the reduced holding force further comprises controlling the reduced holding force to limit the speed of the vehicle to approximately between one to two kilometers per hour.

8. The method of claim 1 further comprising reapplying the holding force after at least one of an accelerator request and a brake request is sensed.

9. The method of claim 1 wherein reducing the holding force after a predetermined amount of time further comprises reducing the holding force after a time greater than the mean time to release the brake pedal and depress the accelerator pedal.

10. A system configured for controlling an electric vehicle, the system comprising:
a processor and memory, wherein the memory comprises instructions to:
apply a holding force that holds the vehicle in a stopped position on a slope; and
if the vehicle speed is substantially zero for a predetermined amount of time and there is no accelerator or brake request, reduce the holding force to remind a driver that the vehicle is in an unparked mode.

11. The system of claim 10, wherein the memory further comprises instructions to control the reduced holding force to limit a speed of the vehicle to a predetermined speed.

12. The system of claim 10, wherein the holding force is a creep torque.

13. The system of claim 10, wherein the holding force is a brake torque.

14. The system of claim 10, wherein the predetermined speed is approximately between one to two kilometers per hour.

15. The system of claim 10, wherein the predetermined amount of time is greater than the mean time it takes to release the brake pedal and depress the accelerator pedal.

16. The system of claim 10, wherein the memory further comprises instructions to reapply the holding force after at least one of an accelerator request and a brake request is sensed.

17. A method for controlling an electric vehicle comprising:
sensing a vehicle speed;
sensing if a driver vehicle door is open;
sensing accelerator and brake inputs; and
applying a parking mode if the vehicle speed is substantially zero for a predetermined amount of time, the driver vehicle door is open, and there is no accelerator or brake request.

18. The method of claim 17 further comprising disabling the parking mode if an accelerator or brake request is sensed.

19. The method of claim 17 further comprising, prior to applying the parking mode, applying a creep torque.

20. The method of claim 19 further comprising removing the creep torque after the parking mode is applied.

21. A system configured for controlling an electric vehicle, the system comprising:
a processor and memory, wherein the memory comprises instructions to:
sense a vehicle speed;
sense if a driver vehicle door is open;
sense accelerator and brake inputs; and
apply a parking mode if the vehicle speed is substantially zero for a predetermined amount of time, the driver vehicle door is open, and there is no accelerator or brake request.

22. The system of claim 21, wherein the memory further comprises instructions to disable the parking mode if an accelerator or brake request is sensed.

23. The system of claim 21, wherein the memory further comprises instructions to, apply a creep torque prior to applying the parking mode.

24. The system of claim 23, wherein the memory further comprises instructions to remove the creep torque after the parking mode is applied.
